(19) United States
(12) Patent Application Publication
(10) Pub. No.: US 2008/0006252 A1
(43) Pub. Date: Jan. 10, 2008

(54) METHOD FOR OPERATING AN INTERNAL COMBUSTION ENGINE USING DIFFERENT FUEL TYPES

(76) Inventor: Ulrich Kramer, Bergisch Gladbach (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/770,882

(22) Filed: Jun. 29, 2007

(30) Foreign Application Priority Data
Jul. 5, 2006 (DE) 102006031052.7

(51) Int. Cl. F02B 43/00

(52) U.S. Cl. 123/575

(57) ABSTRACT

This description relates to a method for operating an internal combustion engine which is designed and suitable for use with at least two different fuel types. The fuel type is determined by an engine controller and adaptation of engine operating parameters is made in response to the fuel type.

### FIELD

The present description relates to a method for operating an internal engine using more than one type of fuel.

### BACKGROUND

As a result of the limited resources of fossilized energy sources, in particular as a result of the limited occurrences of mineral oil as a raw material for the extraction of fuels for operating internal combustion engines, it is increasingly sought to use alternative fuels for operating internal combustion engines.

In addition to gasoline as the traditional spark-ignition fuel, natural gas (CNG), ethanol or fuel mixtures of gasoline and ethanol, for example, are used as fuels in spark-ignition engines. Within the context of the present description, all fuels with which a spark-ignition engine can fundamentally be operated are referred to as spark-ignition fuels or fuels, wherein specific fuels which are characterized by certain fuel properties—such as for example the octane number—are referred to as fuel types.

In the prior art, engine operating parameters such as the control times, the cylinder charge pressure, the engine cooling water temperature, the fuel injection duration, the charge air quantity and/or the like, or else structural parameters such as the compression ratio, are set at the factory, i.e., originally, for operation with different fuel types, without fuel-type-specific adaptation being carried out during operation.

Other concepts known from the prior art for operating an engine with different fuel types include designing the internal combustion engine for the fuel with the highest level of knock resistance. That is to say, the compression ratio, the charge pressure, the cooling temperature and the control time “close intake” are designed or configured for the fuel with the highest level of knock resistance, so that the efficiency of the internal combustion engine is optimized at least for the use of the fuel with the highest level of knock resistance.

These approaches also have disadvantages. For example, they exhibit thermodynamic disadvantages that adversely affect the efficiency of the internal combustion engine, specifically when using fuels with a low level of knock resistance. Specifically, to prevent knocking of internal combustion engines having such a design, the ignition time is moved in the late direction as soon as knocking occurs. That is, as soon as end gas ignition is observed, spark advance is retarded. The movement of the ignition time in the late direction in order to avoid knocking, however, results in efficiency losses.

In still other approaches, the internal combustion engine according to the prior art is often designed for the fuel with the lowest level of knock resistance. In said case, those operating parameters and structural parameters of the internal combustion engine which have an effect on knocking, are designed for the fuel with the lowest level of knock resistance.

These approaches also have disadvantages. Specifically, there are thermodynamic disadvantages that result from the above-mentioned restrictions. Further, the energy contained in a fuel with a higher knock resistance is not efficiently utilized. That is to say, the efficiency of the internal combustion engine of such a design is lower during operation of the internal combustion engine with fuels of relatively high knock resistance than the efficiency which could actually be obtained if the internal combustion engine were designed not for the fuel with the lowest level of knock resistance but for the current fuel having a higher level of knock resistance.

### SUMMARY

The description relates to a method for operating an internal combustion engine which is designed and suitable for use with at least two different fuel types, in which method the fuel type of a fuel situated in a fuel supply system of the internal combustion engine is determined and an adaptation of operating parameters of the internal combustion engine to said fuel type is carried out.

The description also relates to an internal combustion engine for carrying out a method of said type, which internal combustion engine is provided with an engine controller and is designed and suitable for use with at least two different fuel types, and in which internal combustion engine are provided means for determining the fuel type of a fuel situated in a fuel supply system of the internal combustion engine.

Since the different fuel types have different physical and chemical properties, measures must be taken such that an internal combustion engine which is provided and intended for use with different fuel types can be operated with all fuel types despite said different fuel properties. That is to say, the internal combustion engine is to be adapted or designed in such a way that improved operation is possible using all the eligible fuel types. This is carried out by means of a specific adaptation of the operating parameters of the internal combustion engine, for example of the ignition time and of the injection time. Here, “adaptation” within the context of the present description means that an operating parameter is variable and is adapted during operation in a fuel-type-specific manner.

### BRIEF DESCRIPTION OF THE DRAWINGS

The advantages described herein will be more fully understood by reading an example of an embodiment, referred to herein as the Detailed Description, when taken alone or with reference to the drawings, wherein:

FIG. 1 schematically shows the influence of the octane number on the cooling temperature which can be set;

FIG. 2 schematically shows the influence of the octane number on the closing time of the intake which can be set;

FIG. 3 schematically shows the influence of the octane number on the compression ratio which can be set; and

FIG. 4 schematically shows the influence of the octane number on the charge pressure which can be set.

### DETAILED DESCRIPTION

In order to be able to detect end gas ignitions in an air-fuel mixture, the internal combustion engine is generally provided with a knock detection system. For this purpose, at least one acceleration sensor is arranged on the cylinder of the internal combustion engine in order to be able to detect higher engine block frequencies that are caused by an end gas ignition and is characteristic during knocking. The acceleration sensor delivers a signal to the engine controller of the internal combustion engine, and said engine controller moves the ignition time in the late direction.

In one embodiment, the present method provides a determination of the fuel type and an adaptation of the operating parameters of the internal combustion engine, for which reason the corresponding methods according to the prior art for determining the fuel type will be briefly discussed.

Conventional methods for determining the fuel type of a fuel situated in a fuel supply system of an internal combustion engine utilize a lambda probe, which is arranged in the exhaust system of the internal combustion engine and serves to detect the oxygen concentration in the exhaust gas, as a means for determining the fuel type.

On account of the different physical and chemical properties of different fuel types, in particular on account of different calorific values and densities, different quantities of oxygen are converted during the combustion of the air-fuel mixture in the combustion chamber—assuming equal charge air quantities—for an unchanged injection duration, so that the exhaust gas has different oxygen concentrations as a function of the fuel type used in each case.

It is therefore possible using the oxygen concentration detected by means of a lambda probe to infer the fuel type of the fuel situated in the fuel supply system at that time, as long as the corresponding information regarding the physical and chemical properties of the eligible fuel types is present.

An adaptation of the internal combustion engine to different fuels can then be carried out, for example, by changing the injection duration. If the different fuels are, for example, fuel mixtures of gasoline and ethanol, and are therefore characterized by a different ethanol proportion or gasoline proportion, a change in the injection duration can be beneficial for adapting the internal combustion engine to the different fuels or to the different ethanol proportions. Here, it is to be taken into consideration that ethanol has a lower calorific value than gasoline, as a result of which, with increasing ethanol content, a higher overall fuel quantity must be injected in order to release the same level of energy or generate the same mean pressure during a working cycle. It would accordingly be beneficial to increase the injection duration with increasing ethanol content. It is to be noted that the relationships are in fact significantly more complex; for example, the fuel quantity is dependent on the injection pressure and the mixture composition can also be controlled by means of the air quantity.

The present description illustrates a method for operating an internal combustion engine which is designed and suitable for use with at least two different fuel types. In one example, the fuel type of a fuel situated in a fuel supply system of the internal combustion engine is determined and an adaptation of operating parameters of the internal combustion engine to said fuel type is carried out, and in which method; the knock resistance of the fuel type is determined or incorporated; and at least one operating parameter, which has influence on the knock tendency, of the internal combustion engine is adapted in an beneficial manner in terms of efficiency to the knock resistance of the fuel type.

Here, the adaptation is carried out in a beneficial manner in terms of efficiency, i.e., in such a way that the internal combustion engine is operated at a higher efficiency.

The restrictions of the prior art which result from designing the internal combustion engine for the fuel type with the lowest level of knock resistance are eliminated at least partially, i.e., at least with regard to one operating parameter; if appropriate, i.e., optionally also for a plurality of operating parameters, by the method according to the description. Here—in contrast to the distinction made further above between operating parameters and structural parameters—the compression ratio is, within the context of the method according to the description, to be counted among the operating parameters, because or as long as it can be changed or is variable. The thermodynamic disadvantages associated with the restrictive design of the internal combustion engine are reduced.

It is possible to dispense with a displacement of the ignition time in the late direction, which is necessary in the case of the one-sided design of the operating parameters for the fuel with the highest level of knock resistance in order to avoid knocking when the internal combustion engine is operated with fuels of lower levels of knock resistance and leads to losses of efficiency.

According to the present method, at least one operating parameter, which has influence on the knock tendency, of the internal combustion engine is adapted in particular cases, i.e., corresponding to the knock resistance of the fuel type being used at that time, specifically in a manner that improves efficiency.

In practice, the adaptation of the internal combustion engine to different fuel types is generally carried out using different characteristic diagrams for different fuel types or different characteristic diagrams for different levels of knock resistance. This is equivalent to including the knock resistance as an additional operating parameter.

Embodiments of the method are advantageous in which the cooling temperature—as an operating parameter of the internal combustion engine—is adapted to the knock resistance of the fuel type. Here, embodiments of the method are advantageous in which the cooling temperature is raised with increasing knock resistance.

The embodiment in question makes allowance for the fact that the risk of knocking increases with higher temperatures in the cylinder or in the air-fuel mixture. That is to say, the probability of end gas ignitions occurring during compression in the air-fuel mixture situated in the combustion chamber increases with rising temperature. At relatively high temperatures, the requirements for end gas ignition are reached more quickly or sooner than at relatively low temperatures. From that said above, however, it also results that fuel types with a higher level of knock resistance can be heated more intensely, i.e., can tolerate higher temperatures, than fuel types with a relatively low knock resistance without end gas ignitions occurring, i.e., without knocking occurring.

It must also be taken into consideration that the combustion process takes place more efficiently in thermodynamic terms the less heat is dissipated, i.e., the lower the heat losses are. The efficiency increases with reducing heat dissipation. The heat energy extracted, i.e., dissipated from the combustion process is however decisively co-determined by the temperature difference between the combustion chamber charge and the environment. That is to say, the difference between the air-fuel mixture and the cylinder temperature influences the heat dissipation, as a result of which a direct influence can be exerted on the dissipated heat energy, and therefore on the efficiency, by means of a variation of the cylinder temperature or of the cooling temperature which ultimately determines the setting of the cylinder temperature.

The higher the level of knock resistance of a fuel, the higher the temperature in the cylinder and therefore the higher the cooling temperature can be selected in order to increase efficiency without knocking occurring.

FIG. 1 schematically shows the influence of the octane number on the cooling temperature which can be set. Plotted along the abscissa is the octane number as research octane number (RON), and plotted along the ordinate is the cooling temperature.

As can be seen from FIG. 1, the cooling temperature can be and is adapted to the knock resistance of the respective or current fuel type. Here, the cooling temperature is raised with increasing knock resistance, i.e., with increasing octane number.

This approach makes allowance for the fact that the temperature in the cylinder and therefore the cooling temperature can be selected to be higher for fuels with a relatively high octane number, i.e., a relatively high level of knock resistance, than for fuels with a relatively low octane number, i.e., a relatively low level of knock resistance. Efficiency can therefore be increased without knocking occurring.

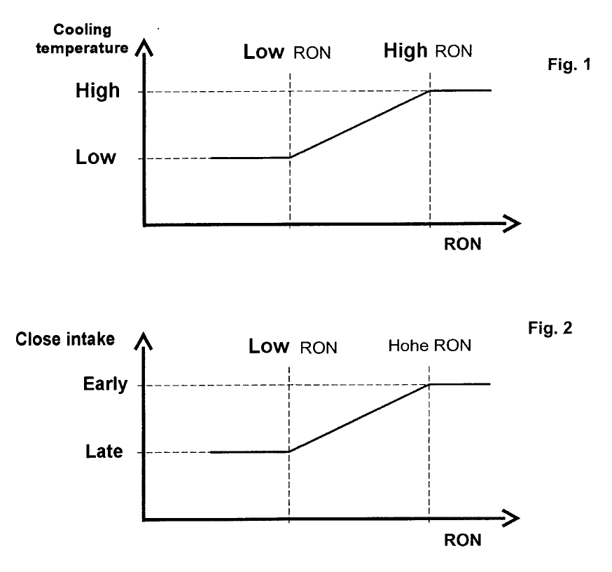

FIG. 2 schematically shows the influence of the octane number on the closing time of the intake valve which can be set. Plotted along the abscissa is the octane number as RON, and plotted along the ordinate is the closing time of the intake.

As can be seen from FIG. 2, the intake valve closing time can be and is adapted to the knock resistance of the respective or current fuel type. Here, the intake valve is closed earlier with increasing knock resistance, i.e., with increasing octane number, resulting in efficiency being increased.

Embodiments of the method are advantageous in which the control times—as an operating parameter of the internal combustion engine—are adapted to the knock resistance of the fuel type. Embodiments of the method are advantageous in which the control time “close intake valve” is adapted to the knock resistance of the fuel type, with the intake valve tending to be closed earlier with increasing knock resistance.

The earlier the intake valve is closed, the higher the effective compression ratio, and therefore the higher the efficiency of the combustion process and of the internal combustion engine. Closing the intake valve earlier results in higher compression temperatures and pressures. Specifically the latter two state variables have an influence on whether or not end gas ignitions occur during compression. The effective compression ratio can be adapted to the respective fuel type by changing the closing time of the intake valve.

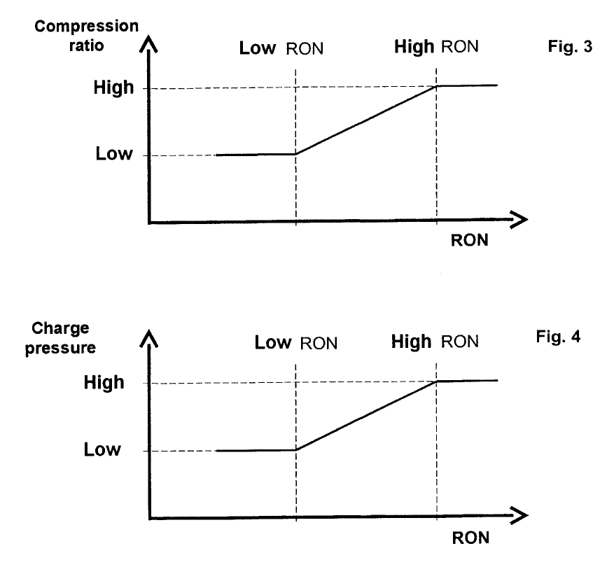

FIG. 3 schematically shows the influence of the octane number on the compression ratio which can be set. Plotted along the abscissa is the octane number as RON, and plotted along the ordinate is the compression ratio.

As can be seen from FIG. 3, the compression ratio can be and is adapted to the knock resistance of the respective or current fuel type. Here, the compression ratio is raised with increasing knock resistance, i.e., with increasing octane number.

Fuel types with a relatively high octane number permit a higher level of compression without end gas ignitions occurring in the air-fuel mixture. The compression ratio has a direct influence on the efficiency of an internal combustion engine, with the efficiency rising with increasing compression ratio.

The fuel-type-specific adaptation of the compression ratio in the case of spark-ignition fuels makes allowance, for example, for the fact that different fuel types have a different level of knock resistance which is specified by the octane numbers RON and motor octane number (MON). That is to say, a fixed compression ratio which permits operation of the internal combustion engine with one specific fuel can, when another fuel is used, lead to knocking.

Embodiments of the method according to the description are advantageous in which the compression ratio—as an operating parameter of the internal combustion engine—is adapted to the knock resistance of the fuel type. Here, embodiments of the method are advantageous in which the compression ratio is raised with increasing knock resistance.

The compression ratio has a direct influence on the efficiency of an internal combustion engine, with the efficiency rising with increasing compression ratio. The embodiment in question therefore contributes to achieving operation of an internal combustion engine at higher efficiency, even when using different fuels.

FIG. 4 schematically shows the influence of the octane number on the charge pressure which can be set. Plotted along the abscissa is the octane number as RON, and plotted along the ordinate is the charge pressure.

As can be seen from FIG. 4, the charge pressure can be and is adapted to the knock resistance of the respective or current fuel type. Here, the charge pressure is raised with increasing knock resistance, i.e., with increasing octane number.

As a result, the load collective can be displaced towards higher loads at which the specific fuel consumption is lower. Increasing the charge pressure is therefore a suitable means for improving the efficiency of the internal combustion engine.

Embodiments of the description are advantageous in which the charge pressure—as an operating parameter of the internal combustion engine—is adapted to the knock resistance of the fuel type. Here, embodiments of the method are advantageous in which the charge pressure is raised with increasing knock resistance.

The supercharging serves primarily to increase the power of the internal combustion engine. Here, the air required for the combustion process is compressed, thereby increasing the charge pressure.

Supercharging is a suitable means for increasing the power of an internal combustion engine with unchanged swept volume or for reducing the swept volume for the same power. In each case, supercharging leads to an increase in the power in relation to the installation space and to a more favorable power-to-mass ratio. It is thus possible, for the same vehicle boundary conditions, to displace the load collective towards higher loads at which the specific fuel consumption is lower. This is also known as downsizing. Supercharging consequently assists with the constant aim in the development of internal combustion engines to minimize the fuel consumption, i.e., to improve the efficiency of the internal combustion engine.

In a second aspect of the present description, an internal combustion engine is provided with an engine controller and is designed and suitable for use with at least two different fuel types, and in which internal combustion engine are provided means for determining the fuel type of a fuel situated in a fuel supply system of the internal combustion engine, which internal combustion engine is characterized in that; the engine controller is adapted in such a way that the knock resistance of the previously determined fuel type can be identified; and different characteristic diagrams for different levels of knock resistance are stored in the engine controller, so that at least one operating parameter of the internal combustion engine can be adapted to the knock resistance of the fuel type.

The lambda probe has already been described within the context of the description of the prior art as a means for determining the fuel type of a fuel situated in a fuel supply system of the internal combustion engine.

Here, the oxygen concentration in the exhaust gas is detected by means of the lambda probe, and the fuel type of the fuel situated in the fuel supply system at that time is determined on the basis of the detected oxygen concentration.

However, said method operates with a certain time delay which is caused by the mode of operation of the method and is therefore unavoidable. The fuel type used can only be determined once some of the fuel to be examined has been burned, the exhaust gases are present as combustion products of the combustion and have passed through the exhaust system, i.e., have reached the lambda probe. Incorrect operation of the internal combustion engine or non-type-specific calibration of the internal combustion engine—at least for one working cycle—is consequently unavoidable. On the other hand, the lambda probe only delivers reliable data once it has reached a certain minimum temperature. In particular after a cold start, the lambda probe requires a certain heating-up period, which can be up to 30 seconds, in order to reach the required operating temperature. In the intervening time, it is not possible to carry out a calibration to the specific fuel type, so that incorrect operation of the internal combustion engine cannot be precluded.

The inventor herein has developed a method for determining fuel type situated in a fuel supply system of an internal combustion engine that uses a pressure sensor. Here, a pressure sensor in a delimitable volume of the fuel supply system is used to determine the pressure drop, in the form of a pressure drop curve, resulting from a fuel leakage flow from said delimitable volume, with the pressure drop curve determined in this way being compared with at least one reference curve from a provided set of at least two reference curves in order to determine the fuel type.

Said method utilizes, on the one hand, the fact that fuels with different physical properties, in particular different viscosities, exhibit different leakage behavior.

On account of the different leakage behavior of the different fuel types, the fuel pressure which is built up in a delimited volume of the fuel supply system is dissipated at different rates, specifically as a function of the respective viscosity of the fuel and therefore as a function of the respective fuel type.

The pressure drop in a delimitable volume of the fuel supply system is therefore characteristic of a particular fuel type, as a result of which the pressure drop or pressure drop curve detected by means of the pressure sensor can be incorporated in identifying, i.e., in determining the fuel situated in the fuel supply system.

For this purpose, the pressure drop curve detected by means of the pressure sensor is compared with at least one reference curve, wherein when the pressure drop curve and a reference curve correspond to a sufficient degree, it can be deduced that the fuel type associated with the reference curve is the fuel type situated in the fuel supply system at that time.

The provided set of reference curves comprises at least two reference curves. If, for example, a spark-ignition engine which is operated with a mixture of gasoline and ethanol is the subject of the examinations, it can be sufficient to provide a reference curve for pure ethanol and a reference curve for gasoline, with the reference curves for fuels with different levels of ethanol or gasoline content being generated by interpolation.

The pressure drop curve is compared with at least one reference curve. The reason for this or for this formulation is that even the first reference curve incorporated for comparison purposes can correspond to the determined pressure drop curve, so that it is no longer necessary to incorporate further reference curves.

Here, the pressure drop in the form of a pressure drop curve can be determined in such a way that the pressure is determined by means of the pressure sensor continuously over time. In addition, the pressure can also be detected at at least two different times, with the pressure drop curve being formed by connecting the at least two pressure values at the at least two times. The fuel type can then be determined by comparing the pressure drop curve with the provided reference curves.

From the pressure drop curve, it is also possible to determine a pressure difference Δpfuel between two pressure values of the pressure drop curve, with said pressure difference being compared to the corresponding pressure differences of the reference curves. In this case, the curves are not compared with one another in the actual sense, i.e., in terms of their shape or profile. It is rather the case that the pressure difference Δpfuel which can be derived from the pressure curve is incorporated for comparison purposes.

Within the context of the present description, a “delimitable volume” does not mean that the volume is hermetically sealed off, as this would preclude a leakage flow, which is imperative. A volume is however delimitable or delimited when the considered subsystem of the fuel supply system has no obvious connection or opening via which the pressure can dissipate without a leakage flow.

A connection or opening of said type to parts of the fuel supply system is present in particular when the at least one injection nozzle for injecting fuel is open, as a result of which the determination of the pressure drop by means of the pressure sensor should preferably be carried out outside of the fuel injection process; this being the case at least if the injection process prevents the pressure in the considered delimited volume from being dissipated as a result of leakage.

In contrast to the method known from the prior art, which uses a lambda probe for determining the fuel type, the present method allows the fuel type to be determined before some of the fuel situated in the fuel supply system has been combusted.

1. A method for operating an internal combustion engine capable of operating on different fuel types, the method comprising:
increasing engine coolant temperature as the octane number of a fuel combusted in said internal combustion engine increases.

2. The method of claim 1 wherein the type of said fuel is determined by an amount of fuel that leaks from a volume of fuel.

3. The method of claim 1 further comprising increasing the cylinder charge pressure as said octane number increases.

4. The method of claim 1 further comprising increasing the compression ratio of said engine as said octane number increases.

5. The method of claim 1 further comprising retarding intake valve timing as said octane increases.

6. A method for operating an internal combustion engine capable of operating on different fuel types, the method comprising:
determining a type of fuel to be combusted by said internal combustion engine; and
increasing engine coolant temperature as the knock resistance of said fuel increases.

7. The method of claim 1 further comprising increasing the cylinder charge pressure as said octane number increases.

8. The method of claim 1 further comprising increasing the compression ratio of said engine as said octane number increases.

9. The method of claim 1 further comprising retarding intake valve timing as said octane increases.
